(19) United States
(12) Patent Application Publication
(10) Pub. No.: US 2004/0210470 A1
(43) Pub. Date: Oct. 21, 2004

(54) System and method for project management

(76) Inventor: John Rusk, New York, NY (US)

Correspondence Address: MORGAN & FINNEGAN, L.L.P., 3 WORLD FINANCIAL CENTER, NEW YORK, NY, 10281-2101, US

(21) Appl. No.: 10/414,941

(22) Filed: Apr. 16, 2003

(51) Int. Cl. G06F 17/60

(52) U.S. Cl. 705/9

(57) ABSTRACT

Systems and methods applicable, for example, in project management. Provided operations include, for instance, operations regarding projects, tasks, subtasks, questions, attachments, users, and/or the like.

### FIELD OF THE INVENTION

This invention relates to systems and methods for project management.

### BACKGROUND OF THE INVENTION

Until recently, many individuals sent faxes infrequently and wrote letters infrequently, and instead often relied on the telephone and face-to-face meetings for the quick exchange of information and project management. With the advent of the fax and the personal computer, many of those individuals began writing short letters and faxing them to each other, frequently creating overflowing inboxes, piles of curling paper, and littered file cabinets.

With the advent of common Internet connections, many of these individuals began writing short emails to each other. Although these individuals suddenly had fast communication in writing, many were creating overflowing email inboxes with unread, not filed, quickly-forgotten messages instructing them to do things.

This situation is far from ideal, and can have negative effects such as constraining the productivity of companies, groups, individuals, and/or the like. Accordingly, there may be interest in technologies providing functionality such as facilitating project management.

### SUMMARY OF THE INVENTION

According to embodiments of the present invention there are provided systems and methods applicable, for example, in project management.

Various embodiments provide, for instance, operations regarding projects, tasks, subtasks, questions, attachments, users, and/or the like.

### BRIEF DESCRIPTION OF THE DRAWINGS

FIG. 1 is a diagram depicting exemplary steps involved in project creation according to various embodiments of the present invention.

FIG. 2 is a diagram depicting exemplary steps involved in task creation according to various embodiments of the present invention.

FIG. 3 is a diagram depicting exemplary steps involved in subtask creation according to various embodiments of the present invention.

FIG. 4 is a diagram depicting exemplary steps involved in question creation according to various embodiments of the present invention.

FIG. 5 is a diagram depicting exemplary steps involved in attachment operations according to various embodiments of the present invention.

FIG. 6 is a diagram depicting exemplary steps involved in pending complete tasks and/or subtasks according to various embodiments of the present invention.

FIG. 7 shows an exemplary general purpose computer employable in various embodiments of the present invention.

### DETAILED DESCRIPTION OF THE INVENTION

General Operation

According to embodiments of the present invention, a variety of operations applicable, for example, to project management may be performed. For example, operations relating to setting up a project, may be performed. As another example, operations relating to the creation of tasks, subtasks, questions, and/or the like may be performed. As yet another example, operations relating to the assignment of tasks, subtasks, questions, and/or the like to users may be performed.

As a further example, operations relating to viewing tasks, subtasks, questions, and/or the like m ay be performed. As another example, operations relating to indicating completion of tasks, subtasks, and/on the like, and operations regarding the answering of questions may be performed.

Various aspects of the present invention will now be discussed in greater detail.

Project Creation

According to various embodiments of the present invention, a user authorized to create a new project could be presented with a GUI (Graphical User Interface) and/or other interface whereby he could indicate his desire to perform that operation. For example, the user could be presented with an appropriate button, link, and/or other GUI element.

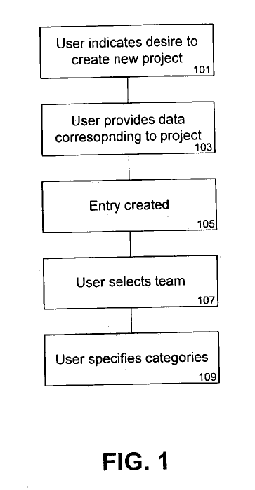

With respect to FIG. 1, it is noted that, in response to the user indicating a desire to create a new project (step 101), the user could be queried for various corresponding data. For example, the user could be queried for a project name, a project start date, a project deadline date, one or more URLs (Universal Resource Locators) or the like corresponding to the project, project comments and/or description, and/or the like. Accordingly, the user could, for instance, be presented with corresponding GUI elements such as fields, pull-down menus, checkboxes, radio buttons, and/or scrollable lists. It is noted that, in various embodiments, certain requested data could be required while other requested data could be optional. For instance, it might be required that a user provide a project name, while project deadline, project comments, and URLs might be optional data.

Next, the user could supply the requested data (step 103). In the case where the user failed to provide required data, the user might be queried to provide that data. Having successfully received requested data from the user, including all required data where appropriate, an appropriate entry corresponding to the new project could be created in an accessible database or other store (step 105). Included in the entry could be, for example the corresponding data provided by the user. In various embodiments, a unique identifier or the like corresponding to the project could be created. Such a unique identifier could be created in a number of ways. For example, random number generation and/or one or more equations could be employed. Where such a unique identifier or the like is created, it might additionally be added to the entry.

As a next step, in various embodiments, the user could be established as an administrator user with respect to the project. Accordingly, for example, an appropriate indication could be placed in an appropriate accessible database or other store.

Next, the user could, in various embodiments, act to select a team of users corresponding to the project (step 107). As will be discussed in greater detail below, the selected team could, for instance, correspond to users to whom tasks, subtasks, questions, and/or the like corresponding to the project could be assigned. Accordingly, the user could, for example, be presented with a list of users and prompted to select users for the team. Such presentation and selection might occur via appropriate GUI elements. After users for the team have been selected, one or more appropriate indications could, in various embodiments, be placed in an accessible database or other store.

It is noted that, in various embodiments, presentation of users for team selection could take into account categories associated with the users. For example, next to each displayed user could be indication of one or more categories associated with that user. As another example, multiple lists of users could be presented, each list displaying only users associated with one or more particular categories. As yet another example, the user could be able to request that he only be shown users corresponding to one or more specified categories. Specification of the categories could, for example, be via one or more appropriate GUI elements. User categories and user establishment will be discussed in greater detail below.

In various embodiments, the user could next be prompted to specify categories for the project. Such specified categories could, for example, be available for association with tasks, subtasks, questions, and/or the like corresponding to the project. Accordingly, the user might, for example, be presented with a list of categories and prompted to choose one or more for association with the project. Such presentation and selection might occur via appropriate GUI elements. The presented categories might, for example, be chosen by a system administrator or the like. After categories have been specified (step 109), one or more appropriate indications could, in various embodiments, be placed in an accessible database or other store.

It is noted that, in various embodiments, as an alternative to or in addition to being able to select from a list of categories as discussed above, the user might be able to define new categories. The user might be able to perform such specification, for example, via one or more appropriate GUI elements.

Categories could, for example, correspond to various functions performed within a particular industry, environment, purpose and/or the like. For example, categories corresponding to construction could include plumbing, electrical, architectural, and/or landscaping. As another example, categories corresponding to building management could include repair, housekeeping, and/or security.

Task and Subtask Creation

According to various embodiments of the present invention, a user authorized to create a new task with respect to a project (e.g., an administrator user with respect to the project) could be presented with a GUI and/or other interface whereby he could indicate his desire to perform that operation. For example, the user could be presented with an appropriate button, link, and/or other GUI element. As a specific example, the user might be presented with such an element via an administrative GUI screen corresponding to a particular project. Such administrative screens will be discussed in greater detail below.

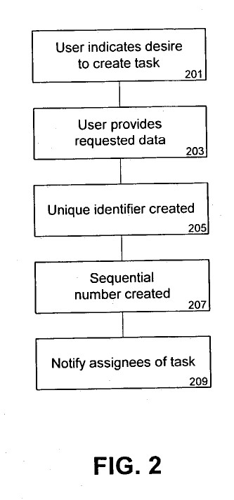

With respect to FIG. 2, it is noted that, in response to the user indicating a desire to create a task with respect to a project (step 201), the user could be queried for various corresponding data. For example, the user could be queried for a task name, a task category, a user to whom the task should be assigned, an indication as to whether or not the task is private, an indication as to whether or not the task is billable, a quoted number amount of time for task completion, task comments and/or description, a task start date, a task due date, and/or the like. In various embodiments a task indicated to be “private” might be viewable only by an assignee and/or users having appropriate privileges. Such a user having appropriate privilege might be, for instance, an administrator user of the sort noted above.

Accordingly, the user could, for instance, be presented with corresponding GUI elements such as fields, pull-down menus, checkboxes, radio buttons, and/or scrollable lists. In various embodiments where the user is queried for a task category, he could be presented with categories specified during project creation as described above. Likewise, in various embodiments where the user is queried for a user to whom the task should be assigned, he could be presented with users corresponding to a team specified during project creation as described above. It is noted that, in various embodiments, certain requested data could be required while other requested data could be optional. For instance, it might be required that a user provide a project name and select a task assignee, while a quoted amount of time for task completion might be optional data. It is further noted that, in various embodiments, a task could be assigned to more than one user.

As a next step, the user could supply the requested data (step 203). In the case where the user failed to provide required data, the user might, in various embodiments, be queried to provide that data. Having successfully received requested data from the user, including all required data where appropriate, an appropriate entry corresponding to the new task could be created in an accessible database or other store. Included in the entry could be, for example the corresponding data provided by the user. In various embodiments, a unique identifier or the like corresponding to the task could be created (step 205). Such a unique identifier could, for instance, be created as discussed above. Where such a unique identifier or the like is created, it might additionally be added to the entry. Further, in various embodiments a sequential number or the like could be associated with the task (step 207). As will be discussed in greater detail below, such sequential numbers could, for example, be employed in displaying tasks to users.

In various embodiments, as a next step operations could be performed to notify the one or more task assignees of the new task (step 209). Such functionality could be implemented in a number of ways. For example, notification could be via email, instant messaging, and/or the like. The notification could, for example, impart that the recipient was an assignee of a new task, and that the user should examine a view of tasks assigned to him in order to learn about the new task. In various embodiments, included with the notification could be a link or the like (e.g., a hyperlink) that the user could employ, for example, in viewing tasks assigned to him and/or the new task. Functionality by which such a user could view tasks assigned to him will be discussed in greater detail below.

In various embodiments of the present invention, an authorized user could act to create one or more subtasks corresponding to a task. Such an authorized user could be, for example, an administrator user with respect to the corresponding project. As another example such a user might be an assignee of the corresponding task. It is noted that, in various embodiments, a user creating a task could be able to indicate that an assignee of the task would not be able to create corresponding subtasks.

According to various embodiments of the present invention, such an authorized user could be presented, for instance, with an appropriate GUI element whereby he could indicate his desire to create a subtask. Such an element might, for example, appear next to each task displayed to a user in a listing of tasks. A user's activation of such an element could be interpreted as an expression of that user's desire to create a subtask relating to the corresponding task.

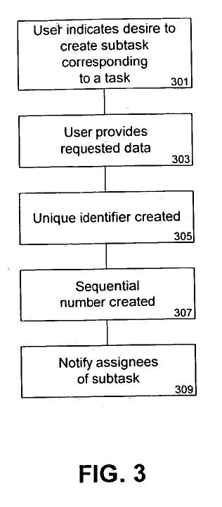

With respect to FIG. 3, it is noted that, in response to a user indicating his desire to create a subtask corresponding to a particular task (step 301), the user could be queried for various corresponding data. For example, the user could be queried for a subtask name, a subtask category, one or more users to whom the subtask should be assigned, a indication as to whether or not the subtask is private, an indication as to whether or not the subtask is billable, a quoted number amount of time for subtask completion, subtask comments and/or description, a subtask start date, a subtask end date, and/or the like. Accordingly, the user could, for example, be presented with appropriate corresponding GUI elements.

As with tasks, a subtask indicated to be “private” could, in various embodiments, be viewable only an assignee and/or users having appropriate privileges. Further as with tasks, certain requested data could be required while other requested data could be optional. Still further as with tasks, in various embodiments a subtask could be assigned to more than one user.

It is noted that, in various embodiments, a user being queried for subtask categories could be presented with categories specified during creation of the corresponding project. Similarly, in various embodiments a user being queried for subtask assignees could be presented with users corresponding to a team specified during creation of the corresponding project. It is further noted that, in certain embodiments, the data of the sort noted above provided by a user with respect to a subtask could be subject to certain constraints regarding the corresponding task. For example, in might be specified that a subtask would have to be marked private in the case where the corresponding task was marked private. As another example, it might be specified that a subtask be assigned to a user of the same category as the user to which the corresponding task was assigned. As yet another example, it might be specified that a quoted amount of time for a subtask be less than or equal to the amount of time quoted in the corresponding task. Such specification could be made, for example, by a user creating the corresponding task, a system administrator, and/or the like.

As a next step, the user could supply the requested data (step 303). As with tasks, in various embodiments the user might next be queried to provide any required data that was not supplied. Having successfully received requested data from the user, including all required data where appropriate, an appropriate entry corresponding to the new subtask could be created in an accessible database or other store. Included in the entry could be, for example the corresponding data provided by the user. In various embodiments, a unique identifier or the like (step 305) and/or a sequential number or the like (step 307) corresponding to the subtask could be created. In a manner analogous to that discussed with respect to tasks, such a unique identifier or the like might, for instance, be added to the entry, while such a sequential number might be employed in displaying subtasks to users.

In various embodiments, as a next step operations could be performed to notify the one or more subtask assignees of the new subtask (step 309). Such functionality could, for example, be implemented in a manner analogous to that discussed above with respect to tasks. The functionality by which a user could view subtasks assigned to him will be discussed in greater detail below.

It is noted that, in various embodiments, certain operations may be performable by certain users but not others. For instance, certain users might be permitted to establish new users while others might not be permitted to do so. It is noted that, in various embodiments of the present invention, a first user may be able to assign a task to a second user requesting that the second user perform a task that the first user is not permitted to perform. Accordingly, as a specific example, a user that is not permitted to establish a new user might request that such be done by a user that is permitted to do so.

Question and Attachment Creation

According to various embodiments of the present invention, an authorized user could act to specify a question with respect to a project to be answered by one or more other users. Such a question might be associated with a task, subtask, or the like, and/or could be a standalone question. A user authorized to specify a question could be, for example, a administrator user with respect to a corresponding project, an assignee of a corresponding task or subtask, and/or a user that created a corresponding task or subtask.

According to various embodiments of the present invention, such an authorized user could, for instance, be presented with an appropriate GUI element whereby he could indicate his desire to specify a question. Such an element might, for example, be displayed next to each task and/or subtask displayed in an administrative screen of the sort noted above, and/or in a view of tasks, subtasks, and/or the like of the sort noted above. A user's activation of such an element could be interpreted as an expression of that user's desire to specify a question relating to the corresponding task or subtask. As another example, such an element could, alternately or additionally, be displayed in a manner not implying association with any particular task or subtask. A user's activation of such an element could be interpreted as an expression of that user's desire to specify a question not relating to any particular task or subtask. Alternately, in response to such activation the user could be queried as to whether he wished the question to be standalone, or if he wished to specify a corresponding task or subtask.

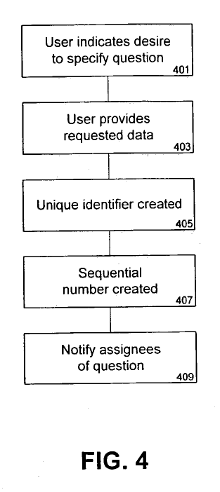

With respect to FIG. 4, it is noted that a user that has indicated a desire to specify a question (step 401) could be queried for various corresponding data. For example, the user could be queried for a question name, question comments and/or description, a question category, a question due date, an indication as to whether or not the question is private, and/or an indication of the user or users to whom the question should be assigned. Accordingly, the user could, for example, be presented with appropriate corresponding GUI elements.

As with tasks, a question indicated to be “private” could, in various embodiments, be viewable only an assignee and/or users having appropriate privileges. Further as with tasks, certain requested data could be required while other requested data could be optional. Moreover, in a manner analogous to that discussed above with respect to subtasks, the data of the sort noted above provided by a user with respect to a question could, in certain embodiments, be subject to certain constraints regarding a corresponding task or subtask. For example, in might be specified that a question would have to be marked private in the case where the corresponding task or subtask was marked private. As another example, it might be specified that a question be assigned to a user of the same category as the user to which the corresponding task or subtask was assigned

Moreover, it is noted that, in various embodiments, the user could specify one or more particular users to whom the question should be assigned. For instance, the user could, perhaps in a manner analogous to that discussed above with respect to tasks, be able to select from among team members specified for a corresponding project. Alternately or additionally, the user might, for example, be able to specify that the question be assigned to all team members specified for a corresponding project, or to all team members of the corresponding project that were associated with one or more specified categories. Where a question is assigned to more than one user, assignment could be implemented such that the action of a single user could serve to answer the question. It is further noted that, in various embodiments, a question could be considered to be assigned to the assignee of a corresponding task and/or subtask, perhaps unless the user who specified the question indicated otherwise.

Next, the user could supply the requested data (step 403). Perhaps in a manner analogous to that discussed above, in various embodiments the user might next be queried to provide any required data that was not supplied. Having successfully received requested data from the user, including all required data where appropriate, an appropriate entry corresponding to the new question could be created in an accessible database or other store. Included in the entry could be, for example, the corresponding data provided by the user. In various embodiments, a unique identifier or the like (step 405) and/or sequential number or the like (step 407) corresponding to the question could be created. Perhaps in a manner analogous to that discussed above, such a unique identifier or the like might be added to the entry, while such a sequential number might be employed in displaying questions to users.

In various embodiments, as a next step operations could be performed to notify the one or more assignees of the new question (step 409). Such functionality could, for example, be implemented in a manner analogous to that discussed above. Functionality by which a user could view questions assigned to him will be discussed in greater detail below.

In various embodiments of the present invention, an authorized user could act to add an attachment with respect to a task, subtask, and/or question. Further, in various embodiments of the present invention, an authorized user could act to add a standalone attachment not relating to any particular task, subtask, question, and/or the like. Such an attachment might be, for example, a file, a link, and/or the like. As specific examples, files and/or links corresponding to images, text documents, cameras and/or other hardware, and/or the like could be added. Accordingly, files and/or links corresponding to blueprints, sketches, photographs, and/or memos could, for example, be added. A user authorized to add an attachment might be, for instance, a administrator user with respect to a corresponding project, an assignee of a corresponding task or subtask, and/or a user that created a corresponding task or subtask.

Such an authorized user could, in various embodiments of the present invention, could be presented with an appropriate button, link, and/or other GUI element whereby he could indicate his desire to specify a question. Such an element might, for example, be displayed next to each task and/or subtask displayed in an administrative screen of the sort noted above and/or in a view of tasks, subtasks, and/or the like assigned to him of the sort noted above. A user's activation of such an element could be interpreted as an expression of that user's desire to add an attachment relating to the corresponding task or subtask. As another example, such an element could, alternately or additionally, be displayed in a manner not implying associating with any particular task or subtask. A user's activation of such a GUI element could be interpreted as an expression of that user's desire to add an attachment not relating to any particular task or subtask. Alternately, in response to such activation the user could be queried as to whether he wished the attachment to be standalone, or if he wished to specify a corresponding task or subtask.

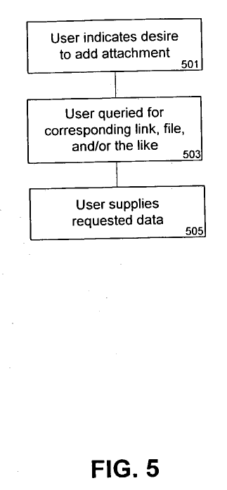

With respect to FIG. 5, it is noted that a user that has indicated a desire to add an attachment (step 501) could be queried for various corresponding data. For example, the user could be presented with appropriate GUI elements whereby he could specify and/or indicate by browsing the corresponding link, file, and/or the like (step 503). As another example, the user could be presented with appropriate GUI elements whereby he could specify, for instance, an attachment name, attachments comments and/or description, an attachment category, an attachment expiration date, an indication as to whether or not the attachment is private, and/or an indication of the user or users that should be able to view and/or otherwise make use of the attachment. In various embodiments, the user could be able to make separate indications regarding whether a user could view the attachment, download the attachment, or edit the attachment. In various embodiments, a user might be able to specify that an attachment be viewable, downloadable, and/or editable by all team members specified for a corresponding project or all team members of the corresponding project that were associated with one or more specified categories.

Perhaps in a manner analogous to that discussed above, an attachment indicated to be “private” could, in various embodiments, be viewable, downloadable, and/or editable only specified users and/or users having appropriate privileges. Further as above, certain requested data could be required while other requested data could be optional. Moreover, in a manner analogous to that discussed above, the data of the sort noted above provided by a user with respect to an attachment could, in certain embodiments, be subject to certain constraints regarding the corresponding task or subtask.

As a next step, the user could supply the requested data (step 505). Perhaps in a manner analogous to that discussed above, in various embodiments the user might next be queried to provide any required data that was not supplied. Having successfully received requested data from the user, including all required data where appropriate, an appropriate entry corresponding to the new attachment could be created in an accessible database or other store. Included in the entry could be, for example the corresponding data provided by the user. In various embodiments, a unique identifier or the like and/or sequential number corresponding to the question could be created. Perhaps in a manner analogous to that discussed above, such a unique identifier or the like might be added to the entry, while such a sequential number might be employed in displaying attachments to users.

View Operations

As alluded to above, according to various embodiments of the present invention a user may be able to view and/or perform actions with regard to tasks, subtasks, questions, attachments, and/or the like. Such a user might do so, for example, in response to a notification of the sort noted above, perhaps via execution of an included link of the sort noted above.

For instance, a user following a link included in a notification and/or performing appropriate login could be presented with a view of tasks, subtasks, questions, attachments, and/or the like, and/or be presented with one or more GUI elements providing him with the ability to request such a view. The view might, for instance, show only tasks, subtasks, and/or questions assigned to the user, and/or attachments that the user was specified as being allowed to view, download, and/or change. Alternately, the user might be able to view, but perhaps not interact with and/or change, tasks, subtasks, questions, and/or the like assigned to others. Whether or not the use could view, interact with, and/or change tasks, subtasks, questions, and/or the like assigned to others might, as will be discussed in greater detail below, depend on his authority level.

Entities such as tasks, subtasks, attachments, questions, and/or the like and or the like could be displayed to a user in a number of ways. For instance, the user could be presented with the title and/or various other information corresponding to each task and/or subtask assigned to him and/or that he is allowed to view. In the case where there is an attachment and/or question that the user is allowed to view, interact with, download, and/or change corresponding to a task or subtask, corresponding GUI elements could, in various embodiments, be displayed next to the task or subtask. As a specific example, a GUI element incorporating the image of a question mark could be displayed in there case where there is a corresponding question, while a GUI element incorporating the image of a paperclip could be displayed in the case where there is a corresponding attachment. In various embodiments, display could take into account sequential numbers of the sort noted above such that, for instance, such entities could be displayed in a order consistent with such numbers.

The view could, in various embodiments, allow the user to select an entity (e.g., a task, subtask, attachment, question, and/or the like) in order to view corresponding details and/or perform corresponding operations.

For example, selecting a task or subtask could allow the user to view the corresponding details alluded to above. Such corresponding details could, for instance, include name, category, assignees, privacy indication, billable indication, a quoted number amount of time for completion, comments and/or description, and/or the like. In the case where the user was authorized to do so (e.g., is an assignee of the task and/or subtask), the user could perform various operations with respect to the task or subtask. For example, the user might, be able to indicate that he had completed the task and/or subtask. In various embodiments, the user might, for instance, be able to and/or be required to provide comments regarding the completion and/or indication of the amount of time that was required for completion.

The user might be able to perform such actions, for instance, by use of appropriate provided GUI elements or the like. In response to such user actions, an entry corresponding to the task and/or subtask could be updated in an appropriate manner. Further, in various embodiments, notification that the task or subtask had been marked as completed could be dispatched, perhaps in a manner analogous to that discussed above, to one or more appropriate users. Such an appropriate user might be, for instance, a user that had created the task or subtask. In various embodiments, such an indication of completion could be interpreted as rendering the corresponding task and/or subtask “pending complete” rather than complete.

It is noted that, in the case where a user indicates that he has completed a task or subtask, in various embodiments operations could be performed so that the task or subtask would no longer be displayed to that user as discussed above. In certain such embodiments, the task or subtask might no longer be displayed only in the case where such indication of completion is not interpreted as rendering the corresponding task or subtask “pending complete” rather than “complete”. It is further noted that in various embodiments where such indication of completion is not interpreted as rendering the corresponding task or subtask “pending complete”, appropriate operations might, perhaps, be performed so that a list of various tasks and subtasks presented to an authorized user could indicate the task or subtask to be “complete”.

Turning again to the display of entities, it is noted that a user could, in various embodiments, be able to select a question or attachment and, in response, be shown corresponding details and/or be allowed to perform corresponding operations. For example, selection of a question by an authorized user could result in that user being able to view the question and/or corresponding details. Where the user was authorized to answer the question, the user could, for example, be provided with appropriate GUI elements to allow him to do so. For instance, the user could be provided with one or more fields allowing him to enter text answering the question.

Upon a user answering a question, the entry corresponding to the task and/or subtask could be updated in an appropriate manner. Further, in various embodiments, notification that the question had been answered could be dispatched, perhaps in a manner analogous to that discussed above, to one or more appropriate users. Such an appropriate user might be, for instance, a user that had specified the question.

With regard to selection of an attachment by an authorized user, it is noted that such selection could, for instance, result in that user being able to view, download, and/or edit the attachment. As alluded to above, the operations the user would be allowed to perform with respect to the attachment could be in accordance with authority and/or specifications. The functionality by which a user could view and/or edit an attachment could be implemented in a number of ways. For instance various software modules could be employed.

As alluded to above, in various embodiments an attachment could specify a link and/or the like to a camera. Such a camera might, for example, be a network-enabled camera including appropriate software and/or hardware to act as a web server offering a webpage allowing for interaction with the camera. Accordingly, user selecting such a camera link could be allowed to interact with the camera, perhaps via a web browsing program operating on his computer. In interacting with the camera, the user might, for instance, be able to see the image created by the camera, and/or cause the camera to zoom in, zoom out, tilt, and/or pan. Such a camera link could be useful in a number of ways. For example, such a camera link could allow a client, foreman, contractor, and/or the like to view the progress of a project. As another example, such a camera link could be provided as an attachment to a task, subtask, question, and/or the like so as provide a view to a corresponding problem, issue, and/or the like. As yet another example, such a camera link could be provided as an attachment in answering a question, indicating a task or subtask to have not been completed to satisfaction, and/or indicating a question to have not been answered to satisfaction, wherein the camera could be employed in answering the question and/or explaining why satisfaction had not been achieved. Further details regarding indicating tasks, subtasks, and questions as not being completed or answered to satisfaction will be discussed in greater detail below.

As alluded to above, a user viewing and/or performing actions with regard to entities such as tasks, subtasks, questions, attachments, and/or the like might, in various embodiments, be able to post questions and/or attachments. For instance, the user might be able to associate a question and/or attachment with a displayed task and/or subtask. As a specific example, the user might act to associate a question in the case where he felt that he needed additional information in order to be able to complete the task. The user's ability to do so could be in accordance with authority and/or other specifications. For example, a user's ability to post questions and/or attachments might be limited to doing so with respect to tasks and/or subtasks for which he was an assignee. The functionality by which a user could post questions and/or attachments could, for instance, be implemented in a manner analogous to that discussed above.

As alluded to above, in various embodiments of the present invention an appropriately authorized user might be able to request creation of one or more subtasks relating to a displayed task. For instance, as alluded to above, the user might be able to request creation of subtasks relating to a task for which he was an assignee. The functionality by which the user could request creation might, for instance, be implemented in a manner analogous to that discussed above.

As described above, various entities, corresponding details, and/or the like could be viewable by a user viewing and/or performing actions with regard to entities such as tasks, subtasks, attachments, and/or the like. It is further noted that, in various embodiments, the user could be able to request printouts of such. For instance, the user might be able to request a printout of displayed entities, corresponding details, and/or the like. Such functionality could be implemented in a number of ways. For example, in the case where entities, corresponding details, and/or the like are displayed by a user aria a web browser or the like, printout might employ functionality provided by the browser. As another example, in the case where a Java client, NET client, and/or the like is employed for such display, the client could be configured, for instance, to make use of printing functionality provided by the operating system upon which the client runs.

Administrative Operations

As alluded to above, according to various embodiments of the present invention an authorized user may be able to perform various administrative operations with respect to one or more projects. Such an authorized user might be, for instance, an administrator user with respect to those projects. Accordingly, such a user following a link included in a notification and/or performing appropriate login could, for example, be presented with and administrative GUI screen and/or one or more GUI elements providing him with the ability to perform such operations. Such a notification could, for instance, be one of the sort noted above indicating that a task or subtask had been indicated to be complete, or one of the sort noted above indicating that a question had been answered.

Among the administrative operations available to such a user could be, for example, the ability to view, delete, download, and/or edit all tasks, subtasks, questions, attachments, and/or the like associated with the project. As another example, the user could be able to add new tasks, subtasks, questions, attachments, and/or the like. Such functionality could, for instance, be implemented in a manner analogous to that discussed above. Another administrative operation available to such a user could be, for example, the ability to view progress of various tasks. In the case where the user selected this operation, he could, for instance, be presented with a list of one or more projects and, for each project, an indication of the extent to which the project had been completed. Such an indication of extent completed might be presented, for instance, as text (e.g., as a percentage) and/or graphically (e.g., in the manner of a bar graph). In various embodiments, additional data might be presented. For instance, the due date of each project might be indicated. The one or more projects presented to the user could, for example, be those for which the user was an administrator user.

As noted above, according to various embodiments an indication of completion of a task or subtask could, in various embodiments, be interpreted as rendering the corresponding task and/or subtask “pending complete” rather than complete. In such embodiments, an available administrative operation could be the ability to change the designation of such tasks and/or subtasks from “pending complete” to “complete”. Accordingly, an authorized user could, for instance, be presented with appropriate GUI elements to perform the operation and/or specify a desire to do so.

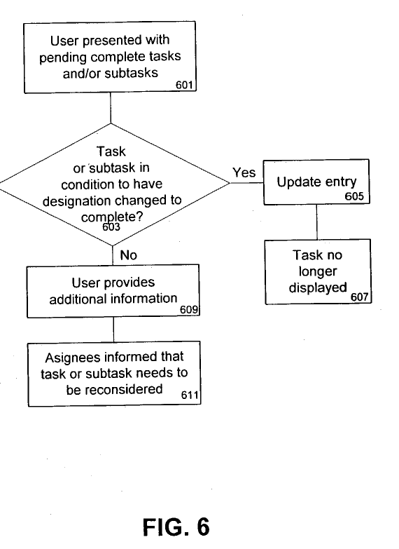

The operation might, for instance, be performable while viewing an appropriate task or subtask as discussed above. With respect to FIG. 6, it is noted that, in various embodiments where a user authorized to perform the operation is presented with a listing of various tasks and/or subtasks, an indication could be displayed in association with each task and subtask considered to be “pending complete” (step 601). As a specific example, a GUI element incorporating the image of a question mark superimposed over a checkmark could be displayed.

In the case where an authorized user, perhaps via provided appropriate GUI elements, indicated that the designation of a particular task or subtask should be changed from “pending complete” to “complete”, an entry corresponding to the task or subtask in an accessible database or other store could be appropriately updated (step 603, 605). In various embodiments, appropriate operations could be performed so that the task or subtask would no longer be displayed to assignees of the task or subtask as discussed above (step 607). Alternately or additionally, appropriate operations could be performed so that a list of various tasks and subtasks presented to an authorized user could indicate the task or subtask to be complete.

In various embodiments, an authorized user could act to indicate that a task or subtask considered to be “pending complete” was not in satisfactory condition to have its designation changed to “complete”. Accordingly the user could, for instance, be presented with appropriate GUI elements to perform the operation and/or specify a desire to do so. An authorized user making such an indication could, in various embodiments, provide additional information (steps 603, 609). For instance, the user might be able to add a corresponding note or the like, the note or the like perhaps providing an explanation as to why the task and or subtask could not be designated as “complete”. As another example, perhaps in a manner analogous to that discussed above, the user might be able to associate a question with the task or subtask.

Upon a user indicating that a certain task or subtask was not in condition to have its designation changed to “complete”, various operations might be performed. For instance, operations analogous to that discussed above regarding the creation of new tasks and/or subtasks could be performed. Accordingly, for example, the assignee or assignees corresponding to the task or subtask could be informed that the task or subtask needed to be reconsidered (step 611), the task or subtask could be displayed to the assignee or assignees along with pending tasks and/or subtasks, and/or the assignee or assignees could be able to view and/or answer any corresponding note, question, or the like.

As noted above, in various embodiments of the present invention questions could be posed and answered. In such embodiments, an available administrative operation could be to view such answers. Accordingly, an authorized-user could, for instance, be presented with appropriate GUI elements to perform the operation and/or specify a desire to do so. According to various of such embodiments, a list of questions presented to an authorized user could provide an appropriate indication next to each listing of an answered question. As another example, a list of tasks and/or subtasks presented to an authorized user could provide an appropriate indication next to each task and/or subtask having a corresponding answered question. Each such indication could, as a specific example, be presented as a GUI element incorporating the image of a cartoon balloon.

For various embodiments, an authorized user not satisfied with the response to question could have various administrative operations available at his disposal. For example the user might, perhaps via appropriate GUI elements, be able to indicate that that answer was not satisfactory. The user might further be able to add a corresponding note, change the original question, and/or append a new question to the old one. Such operations could, for instance, be implemented in a manner analogous to that discussed above.

Upon an authorized user indicating that a response to a question was not satisfactory, various operations might be performed. For instance, operations analogous to that discussed above regarding the posing of a new question could be performed. Accordingly, for example, the assignee or assignees corresponding to the original question could be informed that the question needed to be reconsidered, the corresponding questions and/or notes could be displayed to the assignee or assignees, and/or the assignee or assignees could be able to answer the corresponding questions.

According to various embodiments, a log could be maintained regarding operations performed by various users. The log might, for example, indicate the times such operations were performed, the users that performed the operations, and/or the like. In embodiments where such a log was maintained, an administrative option available to authorized users could, for instance, be to view, print, and/or edit the log. Accordingly, for example, appropriate GUI elements could be provided. The log might, for instance, be maintained in an associated database and/or other store.

As specific examples, the log could record notations regarding the creation of tasks, subtasks, and/or questions, the posting of attachments, the editing and/or downloading of attachments, the indication tasks and/or subtasks to be complete, the answering of questions, designation changes from “pending complete” to “complete”, tasks and/or subtasks not in condition to have their designations changed to “complete”, questions found not to be answered in a satisfactory manner, and/or the like. A maintained log could be useful for a variety of reasons such as, for instance, billing disputes, tax preparation, identifying chronic problems, identifying successful solutions, and/or the like. As a specific example, it is noted that a maintained log might help prevent improper censure of an employee or the like by, for instance, providing a detailed view of the various actions taken in a particular situation.

As noted above, in various embodiments sequential numbers could be associated with, for instance, tasks, subtasks, and/or questions and employed, for instance, in the display of such entities to users. According to various of such embodiments, an administrative option available to authorized users could be to change such sequential numbers. Such change could, for example, have the effect of changing the order in which such entities were displayed to users. In various embodiments, the authorized user could be able to request that a certain entity be inserted between two sequentially-adjacent entities. In response, the sequential numbers associated with one or more entities could be changed to comply with the request.

User Operations

As alluded to above, according to various embodiments of the present invention operations could be performable with regard to users. Such operations might be performable, for instance, by a system administrator and/or authorized user. Accordingly appropriate GUI elements could, for example, be provided.

One such operation could be, for instance, to establish a new user and perhaps specify corresponding aspects. Another such operation could be, for instance, to delete an existing user. Yet another such operation could be, for instance, to change aspects corresponding to an existing user. Aspects corresponding to a user could include, for example, user name, password, contact information, category, authority, and/or the like. Included in contact information could be, for example, one or more email addresses, messaging addresses, telephone numbers, facsimile numbers, website links, mailing addresses, and/or the like.

In various embodiments, the password established for a new user could be a temporary one and/or could be required to be changed to a permanent password chosen by the user. It is further noted that, in various embodiments, it might be possible to change aspects corresponding to an existing user with respect to one or more specifications. Accordingly it might be possible, for example, to temporarily change aspects corresponding to a particular user. As a specific example, it might be possible to specify that aspects corresponding to a particular user be changed for the duration of a particular project, until one or more task and/or subtasks have been completed, and/or the like. As another specific example, it might be possible to specify that aspects corresponding to a particular user be changed for a particular specified period of time.

As noted above, the authority of a user could, in various embodiments, determine the operations that the user could perform. Accordingly, a chosen authority could, for example, specify if a user could view tasks, subtasks, and/or questions other than those assigned to him. As another example, a chosen authority could specify if a user could break an assigned task into subtasks assigned to others. As yet another example, a chosen authority could specify if a user could view, download, and/or edit attachments. As a further example, a chosen authority could specify if a user could create questions, tasks, subtasks, and/or the like. As another example, a chosen authority could specify a user to be an administrative user with respect to one or more projects. It is noted that, in various embodiments, more than one category could be associated with a user.

The category of a user might, for instance, act to describe the skill, skill level, and/or the like possessed by a user. For example, there could be a category relating to carpenters, a category relating to plumbers, a category relating to architects, a category relating to doormen, a category relating to maintenance people, a category relating to tenants, a category relating to customers, and/or a category relating to administrators. As alluded to above, such categories could be employed in various operations such as, for instance, team selection. A category associated with a user could, for instance, be selected from a set of established categories. Such established categories might, for example, be established by a system administrator or the like. In various embodiments, categories could be added to or deleted from the set.

Template Operations

In various embodiments of the present invention, templates employable for various operations relating to the present invention could be employed. For example, templates employable in the creation of tasks, subtasks, and/or questions might be employed. As another example, templates employable in the establishment of users might be employed. As a further example, templates employable in the provision of attachments could be employed. The templates could, in various embodiments, be created, for instance, by an authorized user, a system administrator or the like, perhaps via one or more provide appropriate GUI elements.

Templates could, in various embodiments, be grouped into banks and/or the like. Thus, a particular bank and/or the like could, for instance, contain one or more templates relating to tasks, subtasks, questions, and/or users. Each bank and/or the like could, perhaps, contain templates believed to be employable for one or more industries, purposes, and/or the like. For instance, banks and/or the like relating to construction, contracting, building management, general business, personal organization, and/or the like could be employed.

A template relating to user establishment could, for example, act to specify one or more categories, privileges, and/or the like. A template relating to task, subtask, and/or question creation could act. in a manner somewhat like a fill-in form, wherein certain information could be part of the form, and other information could be provided by a user employing the form and/or retrieved in some other way. Templates relating to attachments could, for example, specify that one or more particular attachments and/or types of attachments should be provided for a particular purpose. As a specific example, a template relating to providing materials to a new tenant might specify that attachments relating to building services, building rules, and neighborhood amenities should be provided. In various embodiments, templates relating to attachments could be associated with tasks, subtasks, and/or question templates. For example, a template for a task relating to renovation of a room might specify that photo attachments corresponding to north, south, east, west, floor, and ceiling views of the room should be provided.

Templates employable in the creation of tasks, subtasks, and/or questions, and/or establishment of users, could, for instance, be available to a user acting to create a task, subtask, and/or question, and/or to establish a user as discussed above. Accordingly the user could, for example, be presented with appropriate GUI elements to indicate his desire to employ a template in such creation. Alternatively, the user might, perhaps in accordance with an associated authority and/or category, be required to employ templates in such creation. Next, the user could act to select a template from one or more indicated templates. Such indication and/or selection might, for instance, occur via appropriate GUI elements.

In various embodiments, the templates indicated to be available could depend on one or more factors. For example, the templates indicated to be available could depend upon properties associated with the user such as authority and/or category. As another example, indicated templates could depend upon an indication provided by the user. For example, the user could indicate that he wished to see templates relating to a particular purpose. As a specific example, the user might indicate the he wished to see templates relating to building maintenance requests.

After a user has selected a template employable in the creation of tasks, subtasks, and/or questions, and/or establishment of users, he could, perhaps, be prompted to prompted to provide certain information as alluded to above. Such provision could, for example, be via appropriate GUI elements. In various embodiments, once the required information had been collected, a task, subtask, or question, and/or the like could be created, and/or the user established, perhaps in a manner analogous to that discussed above.

As a specific example, a user that had selected a template corresponding to creating a task relating to a building maintenance request for a leaky faucet might be prompted for the location of the faucet and/or corresponding details. As alluded to above, in various embodiments, certain information required by the form might be retrieved without querying the user. For example, in the case where the form required an apartment number, such might be found by consulting a database or other store with relation to the user's identifier rather than by querying the user. Upon collection of required information, the task could be created in a manner analogous to that discussed above.

As alluded to above, a bank and/or the like of templates could, as a specific example, relate to building management. Included in such a bank could be, for instance, templates corresponding to access changes, tenant information, service requests, maintenance requests, offering plans, tax information, alteration agreements, tenant board operations (e.g., meeting and work schedules), contractor bid review, renovations, restorations, activity planning (e.g., tenant party planning), package delivery, temporary guests, bookkeeping, capital improvements, and/or staffing.

Further included in such a bank and/or the like could be templates employable in the establishment of users corresponding to, for instance, tenants, managers, superintendents, maintenance workers, doormen, property owners, outside contractors and/or service providers, and/or the like. Employment of the template corresponding to establishment of a tenant user could, for example, result in the establishment of a user whose operations were limited to being able to make maintenance requests and monitor the progress of response to those requests. Employment of the template corresponding to establishment of a maintenance worker user could, for example, result in the establishment of a user whose operations were limited to being able to view and print out tasks, subtasks, questions, and/or corresponding attachments, being able to mark the tasks and/or subtasks as complete (perhaps being able and/or requested to add notes regarding the completion), and being able to answer the questions. Employment of the template corresponding to establishment of a superintendent user could, for example, result in the establishment of a user whose operations were limited to being able to view all tasks corresponding to maintenance requests and/or the like, and being able to assign the tasks to maintenance worker users, perhaps first breaking them down into subtasks. Employment of the template corresponding to establishment of a property owner could, for example, result in the establishment of a user able to perform all possible operations relating to tasks, subtasks, questions, attachments, users, and/or the like corresponding to his property or properties.

Directory Operations

According to various embodiments of the present invention, one or more directories of users could be maintained. Such directories could, for example, contain entries corresponding to users understood to be and/or that presented themselves as being capable of performing tasks and/or subtask of various sorts, answering questions of various sorts, and/or the like. Such directories could, for instance, be assembled, perhaps by an authorized user and/or system administrator, in a manner perhaps analogous to that discussed above with respect to formulation of teams.

Associated with each directory user entry could, perhaps, be one or more categories. As a specific example, a particular user might be listed in the directory in association with the category “plumber”. In various embodiments of the present invention employing one or more directories, a user seeking to assign a task, subtask, question, and/or the like might, as an alternative to and/or in addition do being able to select one or assignees from team members, be able to select one or more assignees from the directory.

A user acting to select one or more assignees via the directory might, perhaps in a manner analogous to that discussed above with respect to selection from among team members, be presented with a list of users from which one or more assignees could be selected. In performing assignee selection using one or more directories, the user might be able to specify one or more categories. A user making such a specification might, for instance, be presented with a list of users from the one or more directories matching the specified categories. It is noted that, in various embodiments, a variety of information corresponding to users listed in a directory could be viewed. Such information could include, for instance, contact information, information regarding licensure, information regarding previous jobs and/or projects, information regarding pricing, references, and/or the like.

As a specific example of a directory entry, there could be an entry corresponding to a user that was associated with the category “plumber”. Accordingly, a user creating a task or subtask requiring a plumber might choose to select an assignee from the directory. Accordingly, the user might, for instance, indicate that he wished to choose one or more assignees from one or more specified directories, and that the one or more assignees should be associated with the category “plumber”. The user might do so, for instance, via one or more appropriate GUI elements.

In response, the user could, perhaps in a manner analogous to that discussed above, be presented a list of appropriate users from the one or more directories and be able to choose one or more of those users as assignees. With respect to the one or more assignees selected from the directory, operations could be performed in a manner analogous to that discussed above with respect to selection of assignees from a team.

Fee Operations

According to various embodiments of the present invention, various fees may be charged. For example, fees could be charged for establishment of a administrator user, the use of templates, the alteration of templates, the creation of templates, project creation, training sessions (e.g., regarding the performance of various operations), special security measures, customization of various features, and/or creating a directory listing.

In various embodiments, various software modules and/or the like might be employed to perform operations relating to fees. For example, one or more modules might act to monitor for the performance of operations for which fees should be charged, and/or to execute the corresponding charges. Operations involved in executing charges could include, for instance, communicating with bank and/or credit card company systems, perhaps employing techniques known in the art.

Hardware and Software

Various operations and the like described herein may be executed by and/or with the help of computers. The phrases “computer”, “general purpose computer”, and the like, as used herein, refer but are not limited to a processor card smart card, a media device, a personal computer, an engineering workstation, a PC, a Macintosh, a PDA, a computerized watch, a wired or wireless terminal, a server, a network access point, a network multicast point, or the like, perhaps running an operating system such as OS X, Linux, Darwin, Windows CE, Windows XP, Windows Server 2003, Palm OS, Symbian OS, or the like, perhaps employing the Series 60 Platform, and perhaps having support for Java alid/or Net.

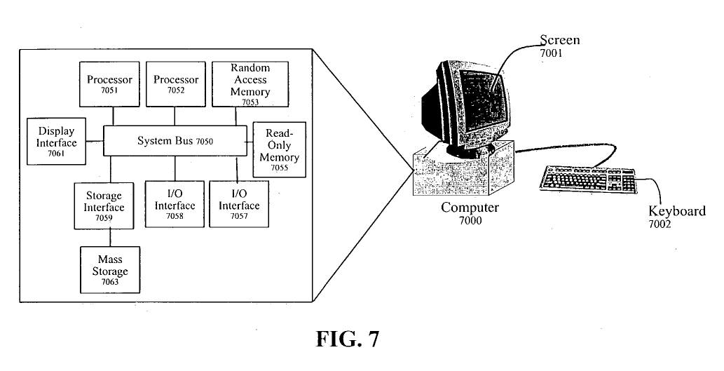

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 7000 as shown in FIG. 7 includes system bus 7050 which operatively connects two processors 7051 and 7052, random access memory 7053, read-only memory 7055, input output (I/O) interfaces 7057 and 7058, storage interface 7059, and display interface 7061. Storage interface 7059 in turn connects to mass storage 7063. Each of I/O interfaces 7057 and 7058 may be an Ethernet, IEEE 1394, IEEE 1394b, IEEE 802.11a, IEEE 802.11b, IEEE 802.11g, IEEE 802.16a, IEEE 802.20, Bluetooth, terrestrial digital video broadcast (DVB-T), satellite digital video broadcast (DVB-S), digital audio broadcast (DAB), general packet radio service (GPRS), Universal Mobile Telecommunications Service (UMTS), DVB-X, IrDA (Infrared Data Association), or other interface known in the art.

Mass storage 7063 may be a hard drive, optical drive, or the like. Processors 7057 and 7058 may each be a commonly known processor such as an IBM or Motorola PowerPC, an AMD Athlon, an AMD Opteron, an Intel ARM, an Intel XScale, a Transmeta Crusoe, an Intel Xenon, or an Intel Pentium. Computer 7000 as shown in this example also includes a touch screen 7001 and a keyboard 7002. In various embodiments, a mouse, keypad, and/or interface might alternately or additionally be employed. Computer 7000 may additionally include or be attached to card readers, DVD drives, floppy disk drives, and/or the like whereby media containing program code may be inserted for the purpose of loading the code onto the computer.

In accordance with the present invention, a computer may run one or more software modules designed to perform one or more of the above-described operations. Such modules might, for example, be programmed using languages such as Java, Objective C, C, C#, and/or C++ according to methods known in the art. Such modules might, for example, communicate via RMI (Remote Method Invocation), JMS (Java Messaging Service), SOAP (Simple Object Access Protocol), and/or the like. Corresponding program code might be placed on media such as, for example, DVD, CD-ROM, and/or floppy disk.

It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that any operations disclosed as being performed by a particular computer might instead be performed by a plurality of computers. It is further noted that, in various embodiments, grid computing techniques may be employed.

In various embodiments, a user wishing to perform various operations of the sort described herein might first be required to perform a logon. For example, the user could be presented with appropriate GUI elements to enter his user name and password. It is further noted that various sorts of interfaces could be employed to allow users to perform operations of the sort described herein.

For example, a web browser could be employed. Such embodiments might employ, for instance, PHP (PHP: Hypertext Preprocessor), ASP (Active Server Pages), ASP+(Active Server Pages +), JSP (Java Server Pages), WebObjects, and/or the like. The web browser could, for instance, be directed towards an appropriate URL, IP (Internet Protocol) address, and/or the like. As alluded to above, such a URL, IP address, and/or the like might, in various embodiments, be included in a received message. As another example, a Java client, Net client, and/or the like might be employed. Such clients might, for instance, communicate via RMI, JMS, SOAP, and/or the like to one or more servers upon which one or more appropriate software modules operated.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for project management, comprising:
receiving from a first user an indication that a task has been completed, wherein said task has been assigned to said first user;
informing a second user of the indication that said task has been completed; and
receiving from said second user an indication regarding whether said task was satisfactorily completed.

2. The method of claim 1, wherein said second user provides an indication regarding actions performed incorrectly by said first user with regard to said task.

3. The method of claim 1, wherein said second user indicates a camera link.

4. The method of claim 3, wherein said second user employs said camera link in providing feedback to said first user regarding actions performed incorrectly by said first user with regard to said task.

5. The method of claim 1, wherein said second user indicates a question for association with said task.

6. The method of claim 1, further comprising informing said first user that said task needs to be reconsidered.

7. The method of claim 1, further comprising informing said second user that said task is considered to be pending complete.

8. The method of claim 1, further comprising receiving from said second user an indication to designate said task as complete.

9. The method of claim 8, further comprising terminating a display of said task to said first user.

10. A method for project management, comprising:
assigning a task to a user;
receiving from said user an indication of one or more subtasks corresponding to said task;
receiving from said user an indication of one or more assignees for one or more of said subtasks; and
assigning one or more of said subtasks in accordance with said indication of one or more assignees.

11. The method of claim 10, further comprising querying said user for data corresponding to one or more of said subtasks.

12. The method of claim 10, wherein said user indicates one or more categories corresponding to one or more of said subtasks.

13. The method of claim 10, wherein said user indicates privacy information corresponding to one or more of said subtasks.

14. The method of claim 10, wherein said user indicates billing information corresponding to one or more of said subtasks.

15. The method of claim 10, wherein said user indicates time estimate information corresponding to one or more of said subtasks.

16. The method of claim 10, wherein said user indicates due date information corresponding to one or more of said subtasks.

17. The method of claim 10, wherein said user indicates comments corresponding to one or more of said subtasks.

18. The method of claim 10, wherein said user indicates one or more questions for association with one or more of said subtasks.

19. The method of claim 10, wherein said user indicates one or more attachments for association with one or more of said subtasks.

20. The method of claim 10, further comprising notifying one or more of said assignees of one or more of said subtasks.

21. The method of claim 11, wherein said data is subject to one or more constraints.

22. The method of claim 21, wherein said one or more constraints relate to said task.

23. A system for project management, comprising:
a memory having program code stored therein; and
a processor disposed in communication with said memory for carrying out instructions in accordance with the stored program code;
wherein said program code, when executed by said processor, causes said processor to perform:
receiving from a first user an indication that a task has been completed, wherein said task has been assigned to said first user;
informing a second user of the indication that said task has been completed; and
receiving from said second user an indication regarding whether said task was satisfactorily completed.

24. The system of claim 23, wherein said second user provides an indication regarding actions performed incorrectly by said first user with regard to said task.

25. The system of claim 23, wherein said second user indicates a camera link.

26. The system of claim 25, wherein said second user employs said camera link in providing feedback to said first user regarding actions performed incorrectly by said first user with regard to said task.

27. The system of claim 23, wherein said second user indicates a question for association with said task.

28. The system of claim 23, wherein said processor further performs informing said first user that said task needs to be reconsidered.

29. The system of claim 23, wherein said processor further performs informing said second user that said task is considered to be pending complete.

30. The system of claim 23, wherein said processor further performs receiving from said second user an indication to designate said task as complete.

31. The system of claim 30, wherein said processor further performs terminating a display of said task to said first user.

32. A system for project management, comprising:
a memory having program code stored therein; and
a processor disposed in communication with said memory for carrying out instructions in accordance with the stored program code;
wherein said program code, when executed by said processor, causes said processor to perform:
assigning a task to a user;
receiving from said user an indication of one or more subtasks corresponding to said task;
receiving from said user an indication of one or more assignees for one or more of said subtasks; and
assigning one or more of said subtasks in accordance with said indication of one or more assignees.

33. The system of claim 32, wherein said processor further performs querying said user for data corresponding to one or more of said subtasks.

34. The system of claim 32, wherein said user indicates one or more categories corresponding to one or more of said subtasks.

35. The system of claim 32, wherein said user indicates privacy information corresponding to one or more of said subtasks.

36. The system of claim 32, wherein said user indicates billing information corresponding to one or more of said subtasks.

37. The system of claim 32, wherein said user indicates time estimate information corresponding to one or more of said subtasks.

38. The system of claim 32, wherein said user indicates due date information corresponding to one or more of said subtasks.

39. The system of claim 32, wherein said user indicates comments corresponding to one or more of said subtasks.

40. The system of claim 32, wherein said user indicates one or more questions for association with one or more of said subtasks.

41. The system of claim 32, wherein said user indicates one or more attachments for association with one or more of said subtasks.

42. The system of claim 32, wherein said processor further performs notifying one or more of said assignees of one or more of said subtasks.

43. The system of claim 33, wherein said data is subject to one or more constraints.

44. The system of claim 43, wherein said one or more constraints relate to said task.
